(19) United States
(12) Patent Application Publication
(10) Pub. No.: US 2007/0184308 A1
(43) Pub. Date: Aug. 9, 2007

(54) Magnetic recording medium with reservoirs and method of manufacture

(75) Inventor: Michael B. Hintz, Mahtomedi, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/349,632

(22) Filed: Feb. 8, 2006

(51) Int. Cl. G11B 5/65; B05D 5/12

(52) U.S. Cl. 428/833.1; 427/130

(57) ABSTRACT

A method of manufacturing a magnetic recording medium includes co-depositing a magnetic material and non-magnetic material over a substrate using a thin-film deposition technique to define a recording layer and removing at least a portion of the non-magnetic material from the recording layer to form reservoirs within the recording layer.

### GOVERNMENT INTEREST

This invention was made with Government support for a Multi-Terabyte Tape Systems Project under NIST ATP 00-00-4939 awarded by the National Institute of Standards and Technology, which is a Government Agency. The Government has certain rights in this invention.

### FIELD OF THE INVENTION

The present invention generally relates to magnetic recording medium, more particularly, to a vapor-deposited thin film magnetic recording medium including overcoat-material reservoirs.

### BACKGROUND

Modern magnetic recording systems such as hard disc drives (HDD) and tape storage systems are extremely complex electromechanical devices. The marketplace demands that the magnetic recording systems be highly reliable. The reliability and performance of magnetic recording systems are influenced by a wide range of factors including the reliability of individual components and subsystems as well as their interaction with one another. Substantially all conventional magnetic recording systems require relative motion between the recording medium and one or more magnetic transducers or heads. Consequently, the stability and reliability of the interface between the recording media and the recording head (referred to herein as the head-to-media interface) is of critical importance to the reliability of the overall magnetic recording system.

The head-to-media interface in modern, high performance recording systems is subject to a number of conflicting constraints. For example, the unrelenting demand for increased storage capacity requires that the magnetic spacing between the recording head and recording media be made as small possible. At the same time, decreased spacing between the recording media and recording head generally tends to make the head-to-media interface less reliable and more prone to catastrophic failure. Consequently, providing a head-to-media interface characterized by a small head-media spacing and a high reliability is a significant engineering challenge.

Historically, the means for providing a reliable head-to-media interface has been different for magnetic tape systems and HDDs. Magnetic recording tapes typically comprise magnetic particles dispersed in a polymeric binder, while magnetic hard discs typically comprise substantially metallic thin-film recording layers deposited by physical vapor deposition (PVD) processes. Hard disks are conventionally manufactured on rigid aluminum or glass substrates greater than 500 micrometers thick, and magnetic recording tapes are conventionally manufactured on flexible and elongated polymeric substrates less than 25 microns thick.

In order to ease any movement of read/write heads over the magnetic recording medium and improve durability of the recording system, a means for protecting and lubricating the recording head to recording medium interface is typically provided. For the case of conventional hard disc drives, a thin layer (2 nm -10 nm) of amorphous carbon-based material is typically deposited on top of the magnetic recording layer, followed by a very thin (0.5 nm-2 nm) layer of lubricant (typically a polyperfluoro ether). The carbon-based layer and lubricant form an overcoat, which serves to lubricate and protect the magnetic recording medium during interactions with drive components, such as the read/write head as well as the environment. Lubricants are generally of increased importance with magnetic recording tapes, since magnetic recording tapes typically directly contact the read/write head and/or guide rollers of the tape drive. In contrast, hard drives are typically read by a head that floats on a cushion of air over the disc medium surface and contacts the disc medium only intermittently.

The polymeric binder in conventional particulate recording tapes typically is mixed with one or more lubricant materials which may migrate through the binder material by diffusion. Commonly, contact between a magnetic recording medium and corresponding drive components, such as the recording head or guide roller, may cause lubricants present on the recording medium surface to migrate, which, consequently, may leave portions of the magnetic recording medium insufficiently lubricated or not lubricated at all. Insufficient lubrication may lead to failure of the head to medium interface resulting in data loss or catastrophic recording system failure. Due to the much more frequent contact between the recording medium and the drive components in a magnetic tape system, more lubricant is generally desired on magnetic recording tape as compared to magnetic hard drives.

In conventional particulate recording tapes comprising lubricant within the polymeric binder, lubricant displaced from the magnetic recording tape surface by mechanical contact with drive or other system components can be replenished by migration of fresh lubricant from within the binder-lubricant material to the tape surface.

From the standpoint of increased recording density, however, the PVD films used in HDDs offer substantial advantages over particulate media, and PVD films are currently under investigation for use in magnetic tape applications. Unlike the situation described for conventional particulate recording tapes, the high density of typical PVD thin-film recording layers does not typically allow incorporation of overcoat materials into the recording layer itself. Consequently, overcoat materials are applied only on the outermost, substantially planar surface of the magnetic recording medium with little or no overcoat material extending even partially into the recording layer. As such, the area of contact between the overcoat material(s) and the recording layer is limited to the substantially planar surface area of the recording layer. The limited contact area between the lubricant and the recording layer allows the lubricant to be more easily displaced on or removed from the recording layer when contacted by a drive mechanism. As described above, such lubricant displacement and/or removal is generally detrimental to the performance and the lifespan of the magnetic recording medium.

### SUMMARY

One aspect of the present invention relates to a method of manufacturing a magnetic recording medium. The method includes co-depositing a magnetic material and non-magnetic material over a substrate using a thin-film deposition technique to define a recording layer and removing at least a portion of the non-magnetic material from the recording layer to form reservoirs within the recording layer.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a cross-sectional schematic illustration of one embodiment of a magnetic recording medium.

FIG. 2 is a cross-sectional schematic illustration of another embodiment of a magnetic recording medium.

FIG. 3 is a plane view Transmission Electron Microscopic (TEM) image of one embodiment of a recording layer of a magnetic recording medium during manufacturing.

FIG. 4 is a cross-sectional TEM image of one embodiment of the magnetic recording medium of FIG. 3.

FIG. 5 is a schematic illustration of one embodiment of a method of manufacturing a magnetic recording medium.

FIG. 6 is a schematic illustration of one embodiment of an etching system used to manufacture a magnetic recording medium.

### DETAILED DESCRIPTION

In the following detailed description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

A magnetic recording medium is formed using thin-film deposition techniques in a manner configured to produce a porous recording layer defining reservoirs or voids. The reservoirs are each at least partially filled with an overcoat including materials such as one or more of a protectant and a lubricant. An overcoat at least partially embedded within the thin-film recording layer provides the magnetic recording medium with a relatively high recording density as compared to conventional particulate magnetic recording media while also permitting a larger volume of overcoat materials to be added to the magnetic recording medium for a given head to medium magnetic spacing as compared with other thin-film recording layers.

A recording layer with embedded overcoat materials is of particular interest in magnetic recording tapes that are directly contacted by guide rollers, read/write heads, etc., as opposed to being read by a floating read/write head as typically used with magnetic hard drives. In one embodiment, during use, lubricant included in the overcoat, which is removed or displaced from the surface of the recording medium during contact with drive components such as read/write heads and guide rollers, can be replenished via migration of fresh lubricant from the sub-surface reservoirs. It should be understood that, although primarily described below with respect to magnetic recording tapes, similar recording layers and or methods of manufacture may also be used with magnetic hard disks and/or other magnetic recording media.

The lubricant migrating from the reservoirs generally replaces or supplements the lubricant originally applied to the surface of the magnetic recording tape that has been removed or has otherwise migrated due to previous or substantially simultaneous interaction with the drive components. As such, a layer of lubricant remains effectively and substantially consistently positioned across the surface of the recording layer for longer periods of time. The more effective and consistent lubrication of the recording layer decreases wear and degradation of the magnetic recording tape, thereby, increasing the life span and performance of the magnetic recording tape.

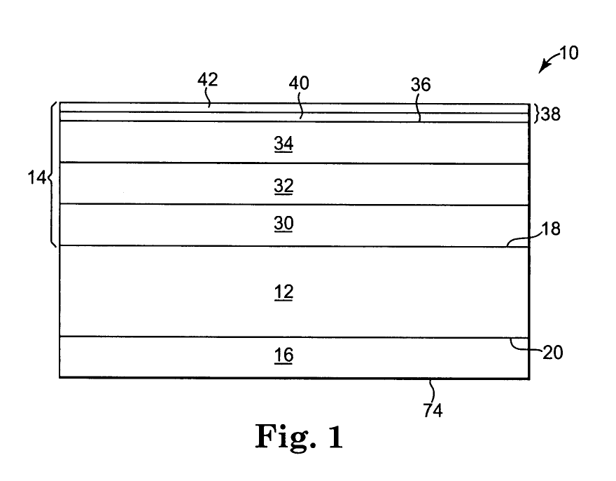

Turning to the figures, FIG. 1 illustrates a schematic, cross-sectional view of one embodiment of a single-sided magnetic recording medium, or more particularly, of a magnetic recording tape 10. In one embodiment, the magnetic recording tape 10 generally includes a substrate 12, a magnetic side 14, and an optional backcoat or backside 16. The substrate 12 defines a first or top surface 18 and a back or bottom surface 20 opposite the top surface 18. The magnetic side 14 generally extends over and, in one embodiment, is directly bonded to the top surface 18 of the substrate 12. The magnetic side 14 comprises the recordable material of the magnetic recording tape 10.

In one embodiment, the magnetic side 14 includes a seed layer 30, an intermediate layer 32, and a recording layer 34 sequentially applied over the substrate 12. The recording layer 34 defines a recording surface 36 opposite the substrate 12. An overcoat 38 is applied to the recording surface 36. In one embodiment, the overcoat 38 includes one or more of a protective material 40 and a lubricant 42. In one example, a thin layer of the protective material 40 is applied to the recording surface 36 and a layer of the lubricant 42 is subsequently deposited on top of the protective material 40. Notably, although illustrated in FIG. 1 as being layers sequentially applied over the recording surface 36, the protective material 40 and the lubricant 42 generally are at least partially impregnated within the recording layer 34 as will be further described below.

As used herein, a first component, such as a substrate, layer, side, etc., extending “over” a second component refers to the first component being layered or deposited across a surface on either side of the second component. As such, the term “over” does not refer to an orientation of either component or to a particular side of the second component, nor does “over” suggest direct interaction between the first and second components.

The backside 16 generally extends over and, in one embodiment, is directly bonded to the bottom surface 20 of the substrate 12. The backside 16 generally alters the tribological and electrical properties for the magnetic recording tape 10. In one embodiment, the magnetic recording tape 10 does not include a backside.

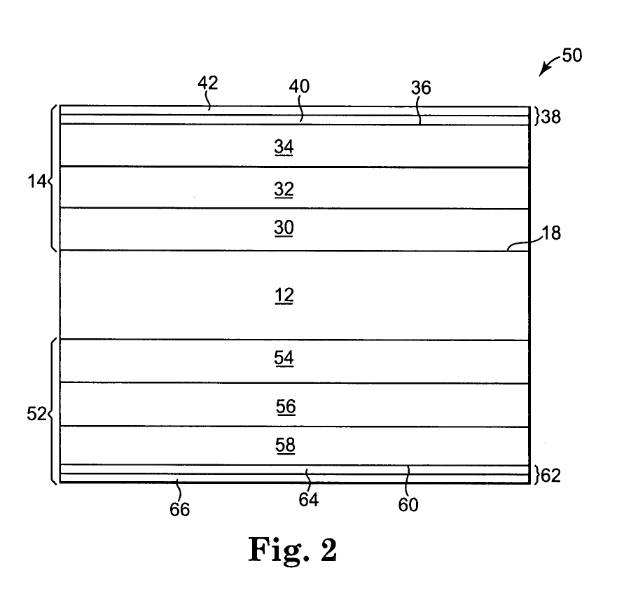

In one embodiment illustrated in FIG. 2, a dual-sided magnetic recording tape 50 is used, which is similar to the magnetic recording tape 10. However, unlike the magnetic recording tape 10, the magnetic recording tape 50 includes a second magnetic side 52 rather than the backside 16 (FIG. 1). The second magnetic side 52 extends over the second magnetic side 52 of the substrate 12 in a similar manner as the first magnetic side 14 extends over the first side 18 of the substrate 12. Accordingly, in one embodiment, the second magnetic side 52 includes a second seed layer 54, a second intermediate layer 56, and a second recording layer 58 similar to the first seed layer 30, the first intermediate layer 32, and the first recording layer 34, respectively. The second recording layer 58 defines a second recording surface 60 opposite the substrate 12.

In one embodiment, a second overcoat 62 similar to the overcoat 38 is applied to the second recording surface 60. In one example, the second overcoat 62 includes a second protective material 64 applied to the second recording surface 60, and a second lubricant 66 applied over the second protective material 64. In one embodiment, the second protective material 64 and the second lubricant 66 are similar to the first protective material 40 and the lubricant 42 and each extend at least partially into an interior of the recording layer 58 (i.e., is at least partially impregnated within the recording layer 58). Although primarily described herein as being a single-sided magnetic recording tape 10, it should be understood that similar manufacture methods and systems can be used to simultaneously or sequentially produce the dual-sided magnetic recording tape 50 with dual recording layers 34 and 58.

The Substrate

The substrate 12 is any non-magnetic substrate suitable as a magnetic recording tape support. Examples of substrate materials useful for the magnetic recording medium 10 include polyesters such as polyethylene terephthalate (PET), polyethylene 2,6 naphthalate (PEN), aromatic polyamide (ARAMID), polyamide (ARAMID), polyimide (PI), polybenzoxazole (PBO). In one example, PET or PEN is preferably employed as the substrate 12. In one embodiment, the substrate 12 is any other suitable substrate configured to withstand the manufacturing process described below, such as thin metallic or inorganic glass sheets, etc. In general, the substrate 12 is in elongated tape form or is an elongated sheet configured to subsequently be cut into elongated tape form or is in a rigid form cut into a predetermined size such as disks. In one embodiment, wherein the substrate 12 is in elongated tape form, the substrate 12 has a thickness of less than 25 microns. In one embodiment, where the magnetic recording medium 10 is a disk, the substrate 12 comprises an aluminum alloy or an inorganic glass.

The Magnetic Side

As described above, in one embodiment, the magnetic side 14 is formed in multi-layer construction including a seed layer 30, the intermediate layer 32, and the recording layer 34. The seed and intermediate layers 30, 32 are configured to improve the performance, life span, or other characteristic of the magnetic recording tape. The seed layer 30 extends over and, in one embodiment, is directly bonded with the top surface 18 of the substrate 12. The intermediate layer 32 extends over the substrate 12. More specifically, the intermediate layer 32 extends over the seed layer 30 opposite the substrate 12. In one embodiment, the intermediate layer 32 is directly bonded to the seed layer 30. In other embodiments, the seed layer 30 is eliminated and the intermediate layer 32 is bonded directly to the substrate 12. The recording layer 34 extends over the intermediate layer 32 opposite the seed layer 30 (or substrate 12) and defines a recording surface 36 opposite the intermediate layer 32. Additional or fewer layers may be included in the magnetic side 14 so long as the recording layer 34 is provided over the substrate 12. For example, a multiplicity of intermediate layers may be used to improve the magnetic properties of the recording layer.

In one embodiment, the recording layer 34 initially includes a mixture of a magnetic material and a non-magnetic material. The inclusion of the non-magnetic material within the recording layer 34 separates at least a portion of the magnetic grains from other magnetic grains. For the invention described herein, the non-magnetic material is configured to subsequently be at least partially removed from the recording layer 34, thereby, forming voids or reservoirs between the magnetic material grains as will be further described below.

In one embodiment, the magnetic material includes at least one of cobalt, nickel, and iron and/or alloys primarily comprising at least one of cobalt, nickel, and iron. In one embodiment, the magnetic material includes a cobalt-based material such as CoCrPt, CoNiPt, and CoCrPtX where X is any suitable additional element.

The non-magnetic material is any suitable non-magnetic material capable of being deposited substantially simultaneously with the magnetic material and subsequently being at least partially removed from the recording layer 34 without substantially removing the magnetic material. In one embodiment, the non-magnetic material is a non-magnetic oxide such as an oxide of silicon, yttrium, zirconium, tantalum, boron, titanium, aluminum, chromium, zinc, lanthanum, indium, lead, etc. In one embodiment, the non-magnetic material is silicon dioxide (SiO₂) and is removable from the recording layer 34 by reactive ion etching, as will be further described below. Use of other non-magnetic materials such as nitrides, etc., suitable for magnetic grain separation within and subsequent removal from the recording layer 34 are also contemplated.

The atomic proportion of the non-magnetic material to the magnetic material varies with the particular non-magnetic material selected, the grain separation desired, and the amount of desired lubricant. In one embodiment, where the non-magnetic material is silicon dioxide, the atomic proportion of the silicon dioxide in the magnetic recording layer ranges from about 10 volume % to about 35 volume %. In general, when the atomic proportion of non-magnetic material becomes too low, there will be insufficient separation between the magnetic material grains to adequately reduce intergranular exchange interactions and subsequently receive the desired amount of overcoat material(s). Conversely, when the atomic proportion of the non-magnetic material becomes too high, the storage density of the magnetic recording tape 10 will generally be lowered to less than suitable levels due to degradation of the recording layer magnetic properties.

In one embodiment, the recording layer 34 is formed with a thickness of about 20 nm. In other embodiments, the recording layer 34 is formed with a thickness ranging from about 5 nm to about 100 nm. The thickness of the recording layer 34 not only impacts the resultant magnetization of the magnetic recording tape 10, but may also impact the size of the reservoirs to be formed therein since shallow reservoirs inherently hold less lubricant and/or other overcoat material than deep reservoirs. As such, the thickness of the recording layer 34 may be varied accordingly to achieve the desired results for a particular application.

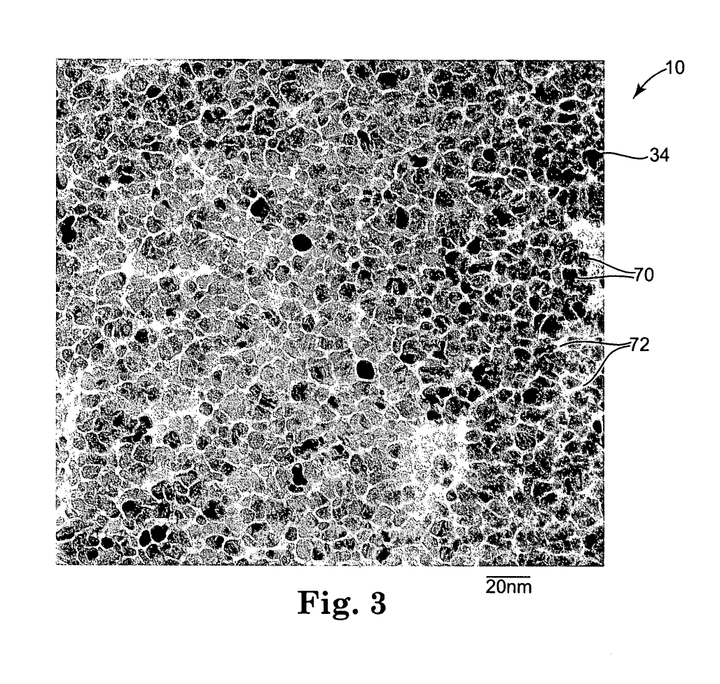

FIG. 3 is a plane-view Transmission Electron Microscopic (TEM) image of one embodiment of a magnetic recording tape 10. The magnetic recording tape 10 pictured in FIG. 2 includes a recording layer 34 including silicon dioxide as the non-magnetic material and that was deposited via sputtering. The dark portions of the image indicate magnetic material grains 70, and the light portions of the image indicate non-magnetic material 72, in this case silicon dioxide. The microscopic image shows the separation of the magnetic material grains 70 caused by phase separation of the magnetic and non-magnetic materials during deposition.

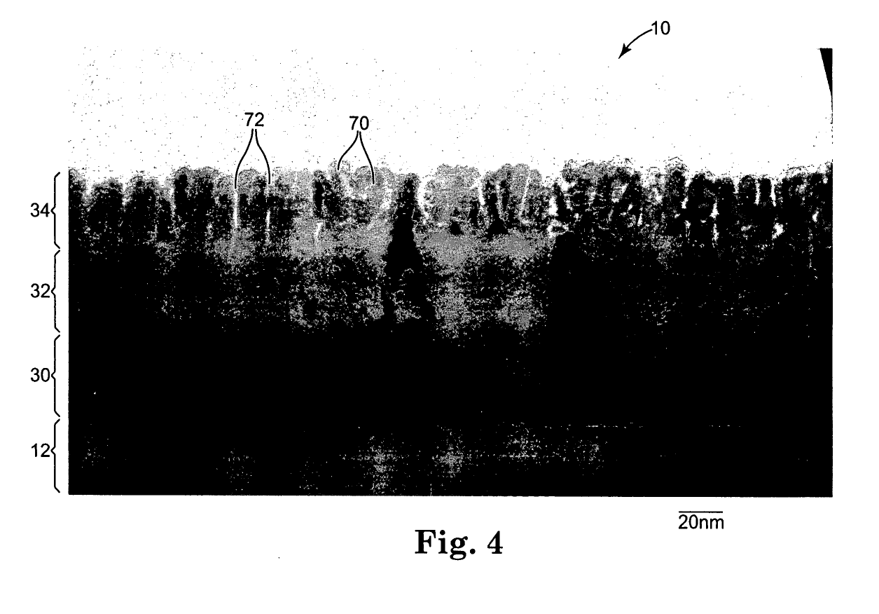

FIG. 4 is a cross-sectional TEM image of the magnetic recording tape 10 of FIG. 3. The image of FIG. 4 shows that the non-magnetic material 72 extends through substantially the entire thickness of the recording layer 34. Accordingly, once the non-magnetic material 72 is removed from the recording layer 34, reservoirs will be formed in the voids left from the non-magnetic material 72. The voids formed by removal of the non-magnetic material from the recording layer may be subsequently filled with appropriate overcoat materials to improve media durability.

Referring once again to FIG. 1, the overcoat may comprise one or more protective materials 40, one or more lubricants 42, or a suitable combination thereof. The protective material 40 is any suitable material configured to increase durability and to enhance read head movement over the magnetic recording tape 10. In one example, the protective material 40 is an amorphous carbon-based material applied over the recording layer 34 to provide a wear and corrosion resistance to the recording layer 34. More particularly, the protective material 40 is applied on top of the recording layer 34 and within at least a portion of the plurality of reservoirs formed therein using any suitable technique such as sputtering, plasma enhanced chemical vapor deposition (PECVD), vacuum evaporation, dip coating, etc.

The lubricant 42 is any suitable composition configured to reduce friction on the recording layer 34 caused by interaction with a read/write head of an associated tape drive. Accordingly, the lubricant 42 improves running durability and corrosion resistance of the magnetic recording tape 10. For example, a lubricant 42 may include one or more of a perfluoropolyether (PFPE) lubricant, such as Zdol, Ztetraol, Zdiac, AM2001, A₂OH, a hydrocarbon lubricant, etc. In one embodiment, a thin layer (0.5 nm-2 nm) of lubricant is coated on top of the recording layer 34 and within the plurality of reservoirs using a dipping, wiping, spraying, or other suitable application technique. In one embodiment, the lubricant is applied by vacuum evaporation or other suitable technique. In one embodiment, the lubricant 42 is applied directly to both the recording surface 36 and within reservoirs formed upon removal of the non-magnetic material from the recording layer; no protective material 40 is deposited. In yet another embodiment, protective material 40 is applied to the porous recording surface 36 prior to application of the lubricant 42.

The Backside

Referring to FIG. 1, in one embodiment, the backside 16 extends over substrate 12 and defines an outermost surface 74 opposite the substrate 12. The backside 16 is coated onto the bottom surface 20 of the substrate 12 to increase the durability of the magnetic recording tape 10. In one embodiment, a lubricant is applied to the outermost surface 74 of the backside 16. In one embodiment, no backside 16 is included in the magnetic recording tape 10. In one embodiment, a second magnetic side 52 (FIG. 2) is included instead of the backside 16.

Method of Manufacture

In hard disks, in some instances, intergranular exchange coupling between magnetic grains in the recording layer is reduced by segregation of a metallic non-magnetic material such as chromium or boron to the magnetic material grain boundaries. Segregation of the metallic non-magnetic material to the magnetic material grain boundaries is conventionally achieved by applying the recording layer using thin-film deposition and while the disk-shaped substrate is heated to about 250 or more degrees Celsius. However, such methods generally are not transferable to use with magnetic recording tapes. More specifically, the substrates used for magnetic recording tapes are generally less heat resistant than hard disk substrates. Consequently, the magnetic recording tape substrates typically melt, deform, expand, and/or contract under the high-heat conditions described above, thereby, rendering the magnetic recording tape greatly impaired or even substantially useless for data storage purposes. In view of the above, in one embodiment, magnetic grain separation is achieved at relatively low temperatures to prevent or at least decrease damage to the magnetic recording tape 10, primarily, to the substrate 12.

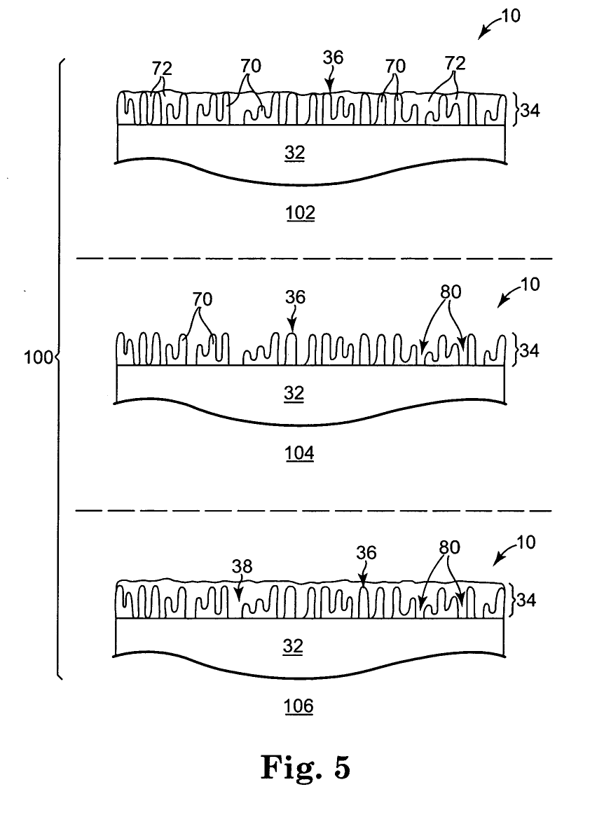

FIG. 5 is a schematic illustration of one embodiment of a method of manufacturing a magnetic storage medium, such as the magnetic recording tape 10, generally at 100. The method includes depositing the recording layer 34 at 102, removing the non-magnetic material at 104, and adding lubricant to the magnetic recording tape at 106. It should be noted that the size and spacing of the magnetic material grains 70 and non-magnetic material 72 are exaggerated in FIG. 5 for illustrative purposes.

Deposition of the Recording Layer

More specifically, in one embodiment, at 102, the recording layer 34 is deposited over the substrate 12 (FIG. 1), more particularly, in one embodiment, over the intermediate layer 32, using any thin-film deposition technique, such as evaporation or sputtering, occurring at relatively low temperatures. In one embodiment, the deposition occurs at about room temperature. In one embodiment, the recording layer 34 is deposited directly on the substrate 12 or on any other layer positioned between the substrate 12 and the recording layer 34. In one example, the recording layer 34 is a sputtered metal film (SMF) deposited using sputtering with a target having a composition similar to the desired composition of the recording layer 34. Accordingly, in one embodiment, the target includes a magnetic material and a non-magnetic material. In sputtering deposition, the magnetic material grains 70 and the non-magnetic material 72 may be co-deposited in the same step (i.e., substantially simultaneously). During deposition, the non-magnetic material 72 may phase separate such that it is at least partially positioned between the magnetic material grains 70, thereby, separating at least a portion of the magnetic material grains 70 from one another. Separation of the magnetic material grains 70 decreases exchange interactions between the magnetic material grains 70 on the magnetic recording tape 10.

Removal of the Non-Magnetic Material

At 104, at least a portion of the non-magnetic material 72 is removed. Removal of the non-magnetic material 72 creates voids or reservoirs 80 between the magnetic material grains 70. In one embodiment, the non-magnetic material 72 is removed in any suitable method that does not substantially degrade or remove the magnetic material grains 70. In one example, the non-magnetic material 72 is removed via etching, leaching, or other method. For instance, in one embodiment, the non-magnetic material 72 is water soluble, such as, for example, yttrium oxide (Y₂O₃). The water soluble non-magnetic material 72 is leached or washed away with water leaving the recording layer 34 primarily including only the magnetic material grains 70 and defining the reservoirs 80.

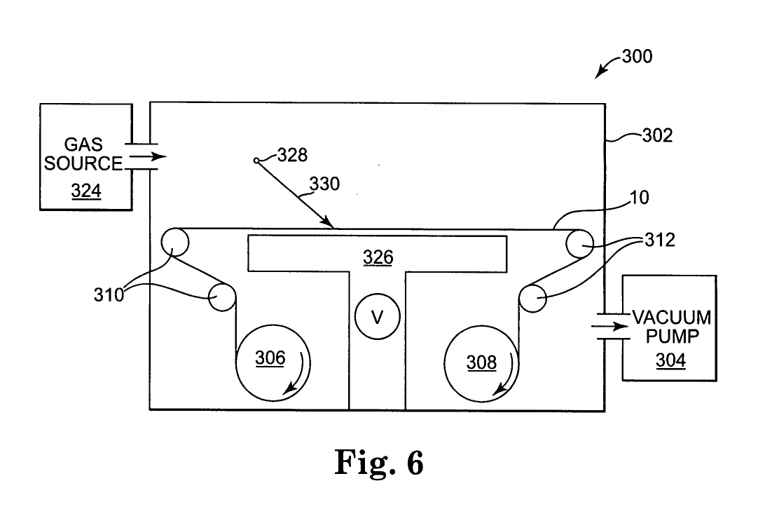

In another embodiment, the non-magnetic material 72 is subsequently removed using a dry process such as reactive ion etching. Reactive ion etching removes material from the magnetic recording tape 10 with a chemical and/or physical interaction between the magnetic recording tape 10 and an etching gas. One embodiment of a reactive ion etching system 300 is generally illustrated in FIG. 6. The reactive ion etching system 300 includes a chamber 302, a vacuum pump 304, a supply roll 306, a take-up roll 308, guide rolls 310 and 312.

In one example, the supply roll 306, the guide rolls 310 and 312, and the take-up roll 308 are each mounted within the chamber 302. In one embodiment, the supply roll 306 is initially wound with a magnetic recording tape 10 not yet overcoated and still including the non-magnetic material 72 (FIG. 5). The magnetic recording tape 10 is configured to extend and move from the supply roll 306, over the guide rolls 310, over the guide rolls 312, and to the take-up roll 308 to form a media path within the chamber 302. In one embodiment, a support 326 extends between guide rolls 310 and 312 and supports or extends beneath a portion of the tape path. The support is configured to apply a negative charge to the magnetic recording tape 10 and/or to have a negative charge itself.

A gas source 324 is coupled and is configured to introduce an etching gas into the chamber 302. In one embodiment, the gas source 324 introduces a reactive etching gas, such as carbon tetrafluoride, other fluorine-based gases, or mixtures of, for example, fluorine-based gases and inert gases, into the chamber 302. Once introduced to the chamber 302, the gas is ionized to produce positively charged etching gas ions, for example, a gas ion generally indicated at 328. Since each gas ion 328 is positively charged and the magnetic recording tape 10 and/or the support 326 is negatively charged, each gas ion 328 is pulled toward the magnetic recording tape 10. In particular, the magnetic recording tape 10 and/or the support 326 is sufficiently charged to accelerate each gas ion 328 toward the magnetic recording tape 10 as generally indicated by arrow 330 in FIG. 6. Additionally, referring to FIG. 5, when the magnetic recording tape 10, more particularly, the recording layer 34 is bombarded with the etching gas, the non-magnetic material 72 and the etching gas chemically reacts to form a gaseous compound that is removed from the etching system by the vacuum pumps. In contrast, the etching gas or gas mixture is selected such that the magnetic material 70 and etching gas do not form a gaseous reaction product; consequently, the magnetic material 70 is only slightly affected by bombardment of the etching gas.

In one embodiment, the etching gas is carbon tetrafluoride and the non-magnetic material is silicon dioxide. The carbon tetrafluoride and the silicon dioxide chemically react to form silicon tetrafluoride gas along with other reaction products. The silicon tetrafluoride is gaseous under the conditions in the reaction chamber, so it mixes with the other gases in the etching chamber and is eventually removed from the chamber 302 via the vacuum pump 304.

In one embodiment, substantially all of the non-magnetic material 72 is removed from the recording layer 34. In one embodiment, less than all of the non-magnetic material 72 is removed from the recording layer 34. Following etching, reservoirs or voids 80 are defined between the magnetic material grains 70 where the non-magnetic material 72 previously resided. In one embodiment, etching of the non-magnetic material 72 does little to no damage to the magnetic material grains 70.

Although generally described as using separate systems for deposition of recording layer 34 and removal of non-magnetic material 72, in one embodiment, the etching system 300 is incorporated into a single system with a deposition system (not shown). For example, in one embodiment, the deposition system and the etching system 300 may both utilize a single chamber and vacuum pump, where deposition occurs in one portion of the chamber and etching occurs in another portion of the chamber. In one embodiment, a similar process and method is simultaneously or sequentially used to produce the second recording layer 58 (FIG. 2) similar to the recording layer 34 with reservoirs defined between the magnetic material grains.

Overcoating the Recording Layer

Once again referring to FIG. 5, at 106 the overcoat 38 is applied to the surface of the recording layer 34 containing reservoirs or pores 80, which were formed in the recording layer 34 due to removal of at least a portion of the non-magnetic material at 104. As such, overcoat 38 is not only maintained on the surface of the recording layer 34 as in prior art, but also penetrates at least partially into the reservoirs 80.

As described previously and with additional reference to FIG. 1, the overcoat 38 may include one or more of the protective material 40 and the lubricant 42. In one embodiment, the protective material 40 is applied to the recording layer 34 by physical vapor deposition processes such as sputtering or chemical vapor deposition processes such as plasma-enhanced chemical vapor deposition or direct ion beam deposition employing carbon-containing gases. Some embodiments may employ a multi-layered application of the protective material 40 or a series of protective materials. Subsequently, a layer of lubricant 42 may be applied by dip coating, vacuum evaporation, or an alternative method. In another embodiment, no protective material 40 is included in the overcoat 38, and the lubricant 42 is applied directly to the porous surface of the recording layer 34. In one embodiment, the protective material 40 and/or the lubricant 42 move into the reservoirs 80 at least in part due to capillary action. In one embodiment, applying the overcoat 38 at 106 includes applying the second overcoat 62 to the second recording layer 58.

After the magnetic recording tape 10 has been overcoated at 106, the magnetic recording tape 10 can be cut and processed, if necessary, for use in magnetic recording tape products. In one embodiment, the magnetic recording tape 10 is at least partially processed before or after any of operations 102, 104, and 106.

Since the overcoat 38 of the magnetic recording tape 10 resulting from the manufacturing method 100 is maintained within the reservoirs 80, the lubricant 42 is not as easily wiped off or moved on the magnetic recording tape 10 during use. Rather, during use, the lubricant 42 from the reservoirs 80 may migrate out onto the recording surface 36, thereby, replacing or supplementing the lubricant 42 in areas of depletion (i.e., areas where the lubricant 42 has been previously removed or wiped away from the recording surface 36 of the magnetic recording tape 10). In view of the above, the magnetic recording tape 10 is more effectively and consistently lubricated than conventional tapes with thin-film recording layers. As such, the reliability and the life span of the magnetic recording tape 10 is increased.

Although primarily described above as depositing the recording layer 34, it should be understood that the second recording layer 58, if any, may be similarly formed as a separate process with a similar system as described for the recording layer 34. In one embodiment, the recording layer 58 is formed by incorporating an additional deposition device(s) similar to the deposition device(s) used to deposit the recording layer 34 within the system described above as will be apparent to those of skill in the art. Moreover, although the method of manufacture 100 is primarily described above with respect to the magnetic recording tape 10, the method of manufacture may also be used to manufacture magnetic hard disks and/or other magnetic recording media. In summary, the present invention enables incorporation of a larger volume of overcoat materials into the recording media for a given magnetic separation between the recording head and the recording media than is the case for previously described overcoating methods. Consequently, recording system durability and performance can be improved.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of manufacturing a magnetic recording medium, the method comprising:
co-depositing a magnetic material and non-magnetic material over a substrate using a thin-film deposition technique to define a recording layer; and
removing at least a portion of the non-magnetic material from the recording layer to form reservoirs within the recording layer.

2. The method of claim 1, further comprising placing at least one of a lubricant material and a protective material into at least a portion of the reservoirs.

3. The method of claim 1, further comprising placing a protective material within at least a portion of the reservoirs, and placing a lubricant within at least a portion of the reservoirs over the protective material.

4. The method of claim 1, wherein the thin-film deposition technique is sputtering.

5. The method of claim 1, wherein removing at least a portion of the non-magnetic material from the recording layer includes using reactive ion etching to remove at least a portion of the non-magnetic material from the recording layer.

6. The method of claim 1, wherein removing at least a portion of the non-magnetic material from the recording layer includes washing at least a portion of the non-magnetic material out of the recording layer.

7. The method of claim 1, wherein the substrate includes polymeric materials.

8. The method of claim 1, wherein the substrate is less than about 25 micrometers thick.

9. The method of claim 1, wherein the non-magnetic material includes a non-magnetic oxide.

10. The method of claim 9, wherein the non-magnetic oxide includes silicon dioxide.

11. The method of claim 1, wherein depositing a magnetic material and non-magnetic material over a substrate results in phase separation of the magnetic material and the non-magnetic material.

12. The method of claim 1, wherein depositing the magnetic material is performed with a substrate maintained at about room temperature.

13. A magnetic recording medium comprising:
a substrate; and
a thin-film recording layer extending over the substrate and including a magnetic material, the recording layer defining a recording surface opposite the substrate and a plurality of reservoirs extending from the recording surface toward the substrate, each of the plurality of reservoirs having been formed by removing a non-magnetic material from the thin-film recording layer, wherein the non-magnetic material was initially co-deposited over the substrate with the magnetic material.

14. The magnetic recording medium of claim 13, wherein the magnetic recording medium is a magnetic recording tape, and the substrate is an elongated substrate.

15. The magnetic recording medium of claim 13, further comprising an overcoat at least partially maintained within at least a portion of the plurality of reservoirs and at least partially extending over the recording surface.

16. The magnetic recording medium of claim 15, wherein the overcoat includes at least one of a protective material and a lubricant.

17. The magnetic recording medium of claim 16, wherein the overcoat includes a protective material and a lubricant each being at least partially maintained within at least a portion of the plurality of reservoirs, and the lubricant being applied over the protective material.

18. The magnetic recording medium of claim 15, wherein the overcoat includes a lubricant maintained within at least a portion of the plurality of reservoirs and at least partially extending over the recording surface.

19. The magnetic recording medium of claim 13, wherein the thin-film recording layer is a first thin-film recording layer extending over a first surface of the substrate, the magnetic recording medium further comprising:
a second thin-film recording layer extending over a second surface of the substrate opposite the first surface, the second thin-film recording layer defining a recording surface opposite the substrate and a plurality of reservoirs extending from the recording surface of the second thin-film recording layer toward the substrate.

20. The magnetic recording medium of claim 13, wherein the substrate is less than 25 micrometers thick.
